(19) United States
(12) Patent Application Publication
(10) Pub. No.: US 2013/0150476 A1
(43) Pub. Date: Jun. 13, 2013

(54) WASHABLE VISCOELASTIC FLEXIBLE POLYURETHANE FOAMS

(71) Applicants: Marc Martin, Lemfoerde (DE); Heinz-Dieter Lutter, Lembruch (DE); Jens Varding, Badbergen/Wohld (DE); Ansgar Frericks, Emsbueren (DE); Edmund Stadler, Hollfeld (DE)

(72) Inventors: Marc Martin, Lemfoerde (DE); Heinz-Dieter Lutter, Lembruch (DE); Jens Varding, Badbergen/Wohld (DE); Ansgar Frericks, Emsbueren (DE); Edmund Stadler, Hollfeld (DE)

(21) Appl. No.: 13/688,908

(22) Filed: Nov. 29, 2012

Related U.S. Application Data
(60) Provisional application No. 61/566,033, filed on Dec. 2, 2011.

(51) Int. Cl. C08J 9/00

(52) U.S. Cl. CPC C08J 9/00
USPC 521/170

(57) ABSTRACT

A process for producing viscoelastic flexible polyurethane foams having an air flow value of at least 1 dm³/s is provided. A polymeric compound having isocyanate-reactive groups in addition to a polyisocyanate is used in the process. The viscoelastic flexible polyurethane foam obtained by such a process and the use of such polyurethane foams for mattresses and cushions are also described.

The present invention relates to a process for producing viscoelastic flexible polyurethane foams having an air flow value of at least 1 dm³/s, which comprises (a) polyisocyanate being mixed with (b) polymeric compounds having isocyanate-reactive groups, (c) optionally chain-extending and/or crosslinking agents, (d) optionally compounds having one isocyanate-reactive group with a hydroxyl number of 100 to 500 mg KOH/g, (e) catalyst, (f) blowing agent, and also optionally (g) addition agents to form a reaction mixture and convert it into flexible polyurethane foam, wherein the polymeric compounds having isocyanate-reactive groups (b) comprise (b1) 10 to 40 wt % of at least one polyalkylene oxide having a hydroxyl number of 90 to 300 mg KOH/g, based on a 3 to 6-functional starter molecule and a propylene oxide fraction, based on the alkylene oxide content, of 80 to 100 wt %, (b2) 5 to 20 wt % of at least one polyalkylene oxide having a hydroxyl number of 10 to 60 mg KOH/g, based on a 2 to 4-functional starter molecule and a propylene oxide fraction, based on the alkylene oxide content, of 80 to 100 wt %, (b3) 10 to 50 wt % of at least one polyalkylene oxide having a hydroxyl number of 10 to 55 mg KOH/g, based on a 2 to 4-functional starter molecule and an ethylene oxide fraction, based on the alkylene oxide content, of 70 to 100 wt %, and (b4) 0 to 20 wt % of at least one polyalkylene oxide having a hydroxyl number of 50 to 200 mg KOH/g, based on a 2-functional starter molecule and an ethylene oxide fraction, based on the alkylene oxide content, of 80 to 100 wt %, and wherein the fraction of compounds b1) to b4), based on the total weight of polymeric compounds having isocyanate-reactive groups (b), is at least 80 wt %. The present invention further relates to a viscoelastic polyurethane foam having an air flow value of at least 1 dm³/s, which is obtainable by such a process, and to the use of such a polyurethane foam for mattresses and cushions.

Viscoelastic flexible polyurethane foams have attained ever greater importance in recent years. They are used in particular for producing upholstery, pillows, mattresses or for vibration damping, for example in carpet backfoaming or in-place cavity foaming. Viscoelastic foams are notable for their slow recovery after compression.

Currently there are two different groups of viscoelastic foams, which differ in cell structure and the mechanism of viscoelasticity.

So-called pneumatically (physically) viscoelastic foams (pVEs) are closed-cell flexible PU foams with perforate cellular membrane, the air flow value of which is very low. On compression, the air is squeezed out of the cells of the foam. On decompression, the air flow value limits the rate at which the foam can relax back into its original shape. Recovery time is therefore dependent on the degree of perforation/open-cell content of the flexible PU foam, inter alia. The higher the closed-cell content of the flexible PU foam, the slower the recovery.

Examples of polyurethane foams with pneumatic viscoelasticity have already been extensively described in the literature and patent documents. As far back as 1989, DE3942330 described a process for producing flexible polyurethane foams having viscoelastic, structureborne sound-damping properties and the polyoxyalkylene-polyol mixtures used therefor.

Viscoelastic properties can be achieved in different ways. U.S. Pat. No. 6,391,935, EP 908478 and WO 2005/003206 respectively describe the use of monools; of cyclic and heterocyclic components; and of certain chain extenders.

Where the patent documents do not differ is that the dominating proportion of polyetherol mixtures is constructed from very hydrophilic building blocks, especially polyethylene oxide units. Furthermore, the cells of the polyurethane foam are overwhelmingly closed-cell with perforation, and so the viscoelastic effect is predominantly due to the low air flow value of the cellular membranes.

The pneumatically viscoelastic polyurethane foams described in the references cited have the disadvantage that the high closed-cell content greatly limits air interchange. Without air interchange, there can be no removal of heat for example from the human body, leading to increased sweating, nor of moist air for example from human perspiration or from washing. Furthermore, the high proportion of hydrophilic polyols means that the foam is very hydrophilic, tends to imbibe water and is only slow to release it again, and therefore tends to swell up. A further disadvantage of these viscoelastic polyurethane foams is their low mechanical strength, as reflected more particularly by low values of tensile strength in particular, which are even worse in the wet state.

Furthermore, the high hydrophilicity of the foams leads to high water imbibition, for example in the form of sweat or on attempting to launder the foam. The water can pass into perforate cells as well as into the hydrophilic matrix of the foam, causing substantial swelling up of the foam. These foams cannot be dried nondestructively owing to their low air flow value.

An attempt to dry these wet foams will frequently cause the cellular membranes to burst or rupture, which leads to the viscoelastic behavior being lost and the foam's scaffolding being destroyed.

So-called structurally or chemically viscoelastic flexible polyurethane foams (cVEs) are notable for their glass transition temperature being in the vicinity of room temperature. Such cVE foams can be open-cell and yet viscoelastic.

Recovery time here is controlled by using a specific polyether polyol composition as well as a more or less freely choosable isocyanate component. An open-cell foam is of advantage for the special comfort expected of mattresses and pillows in particular, since it enables air interchange and provides an improved microclimate.

Examples of open-cell structurally viscoelastic flexible foams (cVEs) have already been extensively described in patent documents and the literature. U.S. Pat. No. 7,022,746 describes an open-cell viscoelastic foam having an ASTM3574G-95 air flow value of up to 3.9 dm³/s coupled with a maximum value of the loss modulus tan delta at 10-12° C. This reference, which includes improved mechanical properties amongst its objects, further describes viscoelastic polyurethane foams having a tensile strength of 37 to 60 kPa. Two main polyols are used in this reference, each with a weight fraction of 30-70 wt %, one polyol consisting of ethylene oxide building blocks to an extent of 70-100 wt % while the second polyol consists of propylene oxide building blocks to an extent of 70-100%. As a result, this foam is minimally more hydrophobic than the foams obtained with exclusively ethylene oxide-based polyols, but especially the swellability in water as well as the tensile strength of these foams is in need of further improvement.

DE102997061883 describes a slabstock foam system which is said to be open-cell, although it first has to be flexed after manufacture. The polyol used is essentially a polyol constructed nearly half and half of PO and EO building blocks.

The foam of DE 102997061883 is closed-cell in the as-produced state, it is only after mechanical flexing that the cellular membranes will burst open to some extent. The patent document does not recite any measured DIN air flow value, but does state that an in-house measurement found an air resistance of 350 mm water column, suggesting a very low air flow. Moreover, foams according to DE102997061883 display a very low tensile strength of 36 kPa.

These disadvantages are said to be compensated by using specific polyols. WO2008002435 describes the use of polyetherols initiated on bisphenol A, which should give increased tensile strength, yet the foams obtained display only tensile strengths of up to 65 kPa.

EP1960452 describes recipes comprising a distinctly reduced fraction of hydrophilic polyol. A person skilled in the art would expect this to result in a distinctly lower water imbibition and lower swelling of the foams. The flexible foams mentioned in the patent document do indeed display reduced swelling in water of just 4-7%. It is likewise stated that the hydrophilic flexible foams mentioned in the prior art are unsuitable owing to their swellability of about 40% in moist media. The foams recited in the patent document again display only low tensile strengths of up to 63 kPa and therefore are not fit for high mechanical loads despite the low water imbibition.

DE10352100 concerns the swelling behavior of viscoelastic foams in water and describes pneumatic viscoelastic foams having improved hydrolysis and aging properties. Also described are foams where there are viscoelastic properties over a wide temperature range. This is achieved through the use of 10-60 wt % of acrylate polyols. Swellability in water is 4% and the tan delta curve promises viscoelastic behavior over a wide temperature range. Tensile strengths are not reported. Disadvantages with using acrylate polyols are the high price and especially the high emissions of acrylates, which become unpleasantly noticeable by odor. These foams further also display a high closed-cell content with the recited disadvantages.

WO2007/144272 describes hydrophobic viscoelastic open-cell slabstock foams comprising TDI as isocyanate component. Polyol components comprising a high proportion of polymeric polyetherols (graft polyethers) are used. Disadvantages are the low tensile strength, reported as 40-60 kPa, and the low air flow value of just 30-60 L/min.

The use of chemically modified or unmodified polyetherols or monools based on renewable raw materials is currently a frequent topic in newly filed applications. These so-called bio-polyols find use in the sector of viscoelastic open-cell foams in EP1981926, WO2009/106240 but also WO2009/032894. Low tensile strength is again a disadvantage in that 70 kPa is the maximum reported in any of the cited patent documents.

The present invention has for its object to provide a viscoelastic flexible polyurethane foam having an outstanding air flow value and a high tensile strength by using essentially customary polyols. The present invention further has for its object to provide a polyurethane foam which can be washed nondestructively, especially in a commercial washing machine using a customary washing powder at temperatures up to 60° C., and subsequently dried without the viscoelastic properties being lost by the washing and drying.

We have found that this object is achieved, surprisingly, by a process for producing viscoelastic flexible polyurethane foams having an air flow value of at least 1 dm³/s, which comprises (a) polyisocyanate being mixed with (b) polymeric compounds having isocyanate-reactive groups, (c) optionally chain-extending and/or crosslinking agents, (d) optionally compounds having one isocyanate-reactive group with a hydroxyl number of 100 to 500 mg KOH/g, (e) catalyst, (f) blowing agent, and also optionally (g) addition agents to form a reaction mixture and convert it into flexible polyurethane foam, wherein the polymeric compounds having isocyanate-reactive groups (b) comprise (b1) 10 to 40 wt % of at least one polyalkylene oxide having a hydroxyl number of 90 to 300 mg KOH/g, based on a 3 to 6-functional starter molecule and a propylene oxide fraction, based on the alkylene oxide content, of 80 to 100 wt %, (b2) 5 to 20 wt % of at least one polyalkylene oxide having a hydroxyl number of 10 to 60 mg KOH/g, based on a 2 to 4-functional starter molecule and a propylene oxide fraction, based on the alkylene oxide content, of 80 to 100 wt %, (b3) 10 to 50 wt % of at least one polyalkylene oxide having a hydroxyl number of 10 to 55 mg KOH/g, based on a 2 to 4-functional starter molecule and an ethylene oxide fraction, based on the alkylene oxide content, of 70 to 100 wt %, and (b4) 0 to 20 wt % of at least one polyalkylene oxide having a hydroxyl number of 50 to 200 mg KOH/g, based on a 2-functional starter molecule and an ethylene oxide fraction, based on the alkylene oxide content, of 80 to 100 wt %, and wherein the fraction of compounds b1) to b4), based on the total weight of polymeric compounds having isocyanate-reactive groups (b), is at least 80 wt %.

The open-cell viscoelastic flexible polyurethane foams of the present invention are characterized by an absolute maximum value for the loss modulus tan delta in the temperature range from −10 to 40° C., preferably in the range from 0 to 35° C., more preferably in the range from 10 to 35° C. and especially in the range from 15 to 30° C. The absolute maximum value of the loss modulus tan delta corresponds to the ASTM D 4065-99 glass transition temperature. The viscoelastic polyurethane foams of the present invention further have a DIN EN ISO 8307 resilience of below 20% and also a high damping behavior, which is reflected by a tan delta value at 20° C. of at least 0.2, preferably at least 0.4 and more preferably at least 0.5. The tan delta is determined using dynamic mechanical analysis (DMA) at a frequency of 1 Hz and a temperature range of −80 to +200° C. at a deformation of 0.3% in line with DIN EN ISO 6721-1, DIN EN ISO 6721-2, DIN EN ISO 6721-7. The temperature program is run in 5° C. steps.

The viscoelastic polyurethane foams of the present invention also display a DIN EN ISO 8307 air flow value of at least 1.0 dm³/s, preferably at least 1.2 dm³/s, more preferably at least 1.4 dm³/s and especially at least 1.5 dm³/s. The density of flexible polyurethane foams according to the present invention is less than 150 g/l, preferably in the range from 20 to 100 g/l, more preferably in the range from 30 to 80 g/l and especially in the range from 40 to 60 g/l.

Useful polyisocyanates a) include in principle any known compounds having two or more isocyanate groups in the molecule, alone or in combination. Diisocyanates are preferable. The process of the present invention preferably utilizes diphenylmethane diisocyanate (MDI), tolylene diisocyanate (TDI), or MDI-TDI mixtures.

The diphenylmethane diisocyanate used can be monomeric diphenyl diisocyanate selected from the group consisting of 2,2′-diphenylmethane diisocyanate, 2,4′-diphenylmethane diisocyanate or 4,4′-diphenylmethane diisocyanate, or mixtures of two or all three isomers, and also mixtures of one or more monomeric diphenylmethane diisocyanates with higher-nuclear homologs of diphenylmethane diisocyanate. The viscosity of diphenylmethane diisocyanate (a1) at 20° C. is preferably less than 200 mPas, more preferably less than 150 mPas and more preferably less than 100 mPas. It is particularly preferable for the proportion of 2,2′-diphenylmethane diisocyanate to be less than 5 wt %, based on the total weight of polyisocyanates (a).

When TDI is used, it will usually be mixtures of the 2,4- and the 2,6-isomer which are used. Commercially available mixtures with 80% 2,4 and 60% 2,6 TDI and 35% 2,4 and 35% 2,6 TDI are particularly preferable.

In place of pure isocyanates or blended with these, so-called modified isocyanates are frequently used. These modified isocyanates may be formed for example through incorporation of groups into the polyisocyanates. Examples of such groups are urethane, allophanate, carbodiimide, uretoneimine, isocyanurate, urea and biuret groups.

Particular preference is given to polyisocyanates modified with urethane groups, these polyisocyanates being typically prepared by reacting the isocyanates with a deficiency of compounds having two or more isocyanate-reactive hydrogen atoms. Compounds formed therefrom are frequently referred to as NCO prepolymers. The compounds used and having two or more isocyanate-reactive hydrogen atoms are preferably polymeric compounds having isocyanate-reactive groups (b) and/or chain-extending and/or crosslinking agents (c).

Particular preference is likewise given to carbodiimide- or uretoneimine-containing polyisocyanates, which are formed by specific catalyzed reaction of isocyanates with themselves. Mixtures of TDI and MDI can also be used.

Polymeric compounds having isocyanate-reactive groups (b) have a number average molecular weight of at least 450 g/mol and more preferably in the range from 460 to 12 000 g/mol and have two or more isocyanate-reactive hydrogen atoms per molecule. Polymeric compounds having isocyanate-reactive groups (b) preferably include polyester alcohols and/or polyether alcohols having a functionality of 2 to 8, especially of 2 to 6 and preferably 2 to 4 and an average equivalent molecular weight in the range from 400 to 3000 g/mol and preferably in the range from 1000 to 2500 g/mol. Polyether alcohols are used in particular.

Polyether alcohols are obtainable by known methods, usually via catalytic addition of alkylene oxides, especially ethylene oxide and/or propylene oxide, onto H-functional starter substances, or via condensation of tetrahydrofuran. When alkylene oxides are used, the products are also known as polyalkylene oxide polyols. Useful H-functional starter substances include especially polyfunctional alcohols and/or amines. Preference is given to using water, dihydric alcohols, for example ethylene glycol, propylene glycol, or butane diols, trihydric alcohols, for example glycerol or trimethylolpropane, and also more highly hydric alcohols, such as pentaerythritol, sugar alcohols, for example sucrose, glucose or sorbitol. Preferable amines are aliphatic amines having up to 10 carbon atoms, for example ethylenediamine, diethylenetriamine, propylenediamine, and also amino alcohols, such as ethanolamine or diethanolamine. The alkylene oxides used are preferably ethylene oxide and/or propylene oxide, while polyether alcohols used for preparing flexible polyurethane foams frequently have an ethylene oxide block added at the chain end. Useful catalysts for the addition reaction of alkylene oxides include especially basic compounds in that potassium hydroxide is industrially the most important one. When the level of unsaturated constituents in the polyether alcohols is to be low, di- or multi metal cyanide compounds, so-called DMC catalysts, can also be used as catalysts. Viscoelastic flexible polyurethane foams are produced using especially two- and/or three-functional polyalkylene oxide polyols.

Useful compounds having two or more active hydrogen atoms further include polyester polyols obtainable for example from organic dicarboxylic acids having 2 to 12 carbon atoms, preferably aliphatic dicarboxylic acids having 8 to 12 carbon atoms, and polyhydric alcohols, preferably diols, having 2 to 12 carbon atoms and preferably 2 to 6 carbon atoms. Useful dicarboxylic acids include for example succinic acid, glutaric acid, adipic acid, suberic acid, azelaic acid, sebacic acid, decanedicarboxylic acid, maleic acid, fumaric acid, phthalic acid, isophthalic acid, terephthalic acid and the isomeric naphthalene dicarboxylic acids. Use of adipic acid is preferable. The dicarboxylic acids can be used not only individually but also mixed with one another. Instead of the free dicarboxylic acids it is also possible to use the corresponding dicarboxylic acid derivatives, for example dicarboxylic esters of alcohols having 1 to 4 carbon atoms or dicarboxylic anhydrides.

Examples of alcohols having two or more hydroxyl groups and especially diols are: ethanediol, diethylene glycol, 1,2-propanediol, 1,3-propanediol, dipropylene glycol, 1,4-butanediol, 1,5-pentanediol, 1,6-hexanediol, 1,10-decanediol, glycerol and trimethylolpropane. Preference is given to using ethanediol, diethylene glycol, 1,4-butanediol, 1,5-pentanediol, 1,6-hexanediol or mixtures of two or more thereof, especially mixtures of 1,4-butanediol, 1,5-pentanediol and 1,6-hexanediol. It is further possible to use polyester polyols formed from lactones, e.g., ε-caprolactone, or hydroxy carboxylic acids, e.g., ω-hydroxycaproic acid and hydroxybenzoic acids. The use of dipropylene glycol is preferred.

The polymeric compounds having isocyanate-reactive groups (b) comprise (b1) 10 to 40 wt % of at least one polyalkylene oxide having a hydroxyl number of 90 to 300 mg KOH/g, based on a 3 to 6-functional starter molecule and a propylene oxide fraction, based on the alkylene oxide content, of 80 to 100 wt %, (b2) 5 to 20 wt % of at least one polyalkylene oxide having a hydroxyl number of 10 to 60 mg KOH/g, based on a 2 to 4-functional starter molecule and a propylene oxide fraction, based on the alkylene oxide content, of 80 to 100 wt %, (b3) 10 to 50 wt % of at least one polyalkylene oxide having a hydroxyl number of 10 to 55 mg KOH/g, based on a 2 to 4-functional starter molecule and an ethylene oxide fraction, based on the alkylene oxide content, of 70 to 100 wt %, and (b4) 0 to 20 wt %, preferably 1-20 wt % of at least one polyalkylene oxide having a hydroxyl number of 50 to 200 mg KOH/g, preferably 56-200 mg KOH/g, based on a 2-functional starter molecule and an ethylene oxide fraction, based on the alkylene oxide content, of 80 to 100 wt %, all based on the total weight of polymeric compounds having isocyanate-reactive groups (b).

It is preferable to use exclusively polyether polyols as polymeric compounds having isocyanate-reactive groups (b). It is essential here for the purposes of the present invention that the polymeric compounds having isocyanate-reactive groups (b) comprise the polyetherols (b1) to (b4) at not less than 80 wt %, preferably not less than 85 wt %, more preferably not less than 90 wt % and especially not less than 95 wt %, all based on the total weight of the polymer compounds having isocyanate-reactive groups (b). In an especially preferred embodiment of the present invention, the polymeric compounds having isocyanate-reactive groups (b), in addition to the polyetherols (b1) to (b4) do not contain any further polymeric compounds having isocyanate-reactive groups.

It is particularly preferable for the polyetherols of the present invention, aside from the starter, to include essentially exclusively ethylene oxide and propylene oxide units. Here “essentially” is to be understood as meaning that small amounts of other alkylene oxide units are not disadvantageous. The fraction of alkylene oxide units other than ethylene oxide or propylene oxide units is preferably less than 5 wt %, more preferably less than 1 wt % and especially 0 wt %, all based on the total weight of alkylene oxide units.

The chain-extending agents and/or crosslinking agents (c) used are substances having a molecular weight of below 400 g/mol and preferably in the range from 60 to 350 g/mol, chain extenders having 2 isocyanate-reactive hydrogen atoms and crosslinkers having 3 or more isocyanate-reactive hydrogen atoms. These can be used individually or in the form of mixtures. Preference is given to using diols and/or triols having molecular weights less than 400, more preferably in the range from 60 to 300 and especially in the range from 60 to 150. Possibilities are for example, aliphatic, cycloaliphatic and/or aromatic diols, and also diols having aromatic structures, with 2 to 14 and preferably 2 to 10 carbon atoms, such as ethylene glycol, 1,3-propanediol, 1,10-decanediol, o-dihydroxycyclohexane, m-dihydroxycyclohexane, p-dihydroxycyclohexane, diethylene glycol, dipropylene glycol and preferably 1,4-butanediol, 1,6-hexanediol and bis(2-hydroxyethyl)hydroquinone, triols, such as 1,2,4-trihydroxycyclohexane, 1,3,5-trihydroxycyclohexane, glycerol and trimethylolpropane, and low molecular weight hydroxyl-containing polyalkylene oxides based on ethylene oxide and/or 1,2-propylene oxide and the aforementioned diols and/or triols as starter molecules. Particular preference for use as chain extenders (d) is given to monoethylene glycol, 1,4-butanediol and/or glycerol.

When chain-extending agents, crosslinking agents or mixtures thereof are used, the amounts in which they are used are advantageously in the range from 0.1 to 20 wt %, preferably in the range from 0.5 to 10 wt % and especially in the range from 0.8 to 5 wt %, based on the weight of components (b) and (c).

In addition to polymeric compounds having isocyanate-reactive groups, it is optionally also possible to use one or more compounds having just one isocyanate-reactive group (d). These compounds are for example monoamines, monothiols and/or monoalcohols, for example based on polyethers, polyesters or polyether-polyesters. Monoalcohols used for example are more preferably polyether monools obtained on the basis of monofunctional starter molecules, for example ethylene glycol monomethyl ether. These are obtainable similarly to the polyetherols described above via polymerization of alkylene oxide onto the starter molecule. Polyether monools preferably have a high proportion of primary OH groups. It is particularly preferable to prepare polyether monools using ethylene oxide as sole alkylene oxide. Preferable monools further include compounds having an aromatic group. The number average molecular weight of compounds having one isocyanate-reactive group is preferably in the range from 50 to 1000 g/mol, more preferably in the range from 80 to 300 g/mol and especially in the range from 100 to 200 g/mol. When compounds having one isocyanate-reactive group (d) are used, they are preferably used in a proportion of 0.1 to 5 wt % and more preferably 0.5 to 4.5 wt %, based on the total weight of polymeric compounds having isocyanate-reactive groups (b) and compounds having just one isocyanate-reactive group (d).

Useful catalysts (e) for preparing the viscoelastic polyurethane foams are preferably compounds which greatly speed the reaction of the hydroxyl-containing compounds of components (b), (c) and optionally (d) with the polyisocyanates (a) and/or the reaction of isocyanates with water. Examples are amidines, such as 2,3-dimethyl-3,4,5,6-tetrahydropyrimidine, tertiary amines, such as triethylamine, tributylamine, dimethylbenzylamine, N-methylmorpholine, N-ethylmorpholine, N-cyclohexylmorpholine, N,N,N′,N′-tetramethylethylenediamine, N,N,N′,N′-tetramethylbutanediamine, N,N,N′,N′-tetramethylhexanediamine, pentamethyldiethylene-triamine, tetramethyldiaminoethyl ether, bis(dimethylaminopropyl)urea, dimethylpiperazine, 1,2-dimethylimidazole, 1-azabicyclo-(3,3,0)-octane and preferably 1,4-diazabicyclo-(2,2,2)-octane and alkanolamine compounds, such as triethanolamine, triisopropanolamine, N-methyl-diethanolamine, N-ethyldiethanolamine and dimethylethanolamine. Similarly suitable are organic metal compounds, preferably organic tin compounds, such as tin(II) salts of organic carboxylic acids, e.g., tin(II) acetate, tin(II) octoate, tin(II) ethylhexanoate and tin(II) laurate, and the dialkyltin(IV) salts of organic carboxylic acids, for example dibutyltin diacetate, dibutyltin dilaurate, dibutyltin maleate and dioctyltin diacetate, and also bismuth carboxylates, such as bismuth(III) neodecanoate, bismuth 2-ethylhexanoate and bismuth octanoate, or mixtures thereof. The organic metal compounds can be used alone or preferably in combination with strong basic amines. When component (b) is an ester, it is preferable to use exclusively amine catalysts.

Preference is given to using from 0.001 to 5 wt % and especially from 0.05 to 2 wt % of catalyst or catalyst combination, based on the weight of component (b).

Polyurethane foams are further produced in the presence of one or more blowing agents (f). By way of blowing agents (f) it is possible to use chemically acting blowing agent and/or physically acting compounds. Chemical blowing agents are compounds which react with isocyanate to form gaseous products, for example water or formic acid. Physical blowing agents are compounds that have been dissolved or emulsified in the reactants of polyurethane synthesis and vaporize under the conditions of polyurethane formation. Examples are hydrocarbons, halogenated hydrocarbons and other compounds, for example perfluorinated alkanes, such as perfluorohexane, chlorofluorocarbons, and ethers, esters, ketones and/or acetals, for example (cyclo)aliphatic hydrocarbons having 4 to 8 carbon atoms, hydrofluorocarbons, such as Solkanes® 365 mfc, or gases, such as carbon dioxide. In one preferable embodiment, the blowing agent used is a mixture of these blowing agents, comprising water and more preferably exclusively water.

The level of physical blowing agents (f), if present, in a preferable embodiment is in the range between 1 and 20 wt % and especially 5 and 20 wt %, the amount of water is preferably in the range between 0.5 and 8 wt % and more preferably between 0.8 and 6 wt % and especially between 1 and 5 wt %, all based on the total weight of components (a) to (g).

Useful auxiliaries and/or addition agents (g) include for example surface-active substances, foam stabilizers, cell regulators, external and internal release agents, fillers, pigments, dyes, flame retardants, antistats, hydrolysis control agents and also fungistats and bacteriostats.

Further particulars about the starting materials used appear for example in Kunststoffhandbuch, volume 7, Polyurethanes, edited by Günter Oertel, Carl-Hanser-Verlag, Munich, 3^{rd} edition 1993, chapter 5, Flexible polyurethane foams.

To produce the viscoelastic polyurethane foams of the present invention, the polymeric compounds having isocyanate-reactive groups (b), the optionally used chain-extending and/or crosslinking agents (c), the optionally used compounds having just one isocyanate-reactive group with a hydroxyl number of 100 to 500 mg KOH/g (d), the catalysts (e), the blowing agents (f), and also the optionally used auxiliaries and/or addition agents (g) are typically mixed to form a so-called polyol component and reacted in that form with the polyisocyanates a).

To produce the viscoelastic polyurethane foams of the present invention, the polyisocyanate prepolymers are reacted with the polymeric compounds having isocyanate-reactive groups in the presence of the recited blowing agents, catalysts and auxiliary and/or addition agents (polyol component). The mixing ratios are chosen here such that the equivalence ratio of NCO groups of polyisocyanates (a) to the sum total of reactive hydrogen atoms of components (b) and (f) and also, if present, (c) and (d) is preferably in the range from 0.65 to 1.2:1, preferably in the range from 0.7 to 1.1:1 and especially in the range from 0.1 to 1:1. A ratio of 1:1 here corresponds to an isocyanate index of 100.

The polyurethane foams of the present invention are preferably produced by the one-shot process, for example using the high-pressure or low-pressure technique. The foams are obtainable in open or closed metallic molds or via the continuous application of the reaction mixture to belt lines or in troughs to produce foam blocks.

It is particularly advantageous to proceed via the so-called two-component process wherein, as mentioned above, a polyol component is produced and foamed with polyisocyanate a). The components are preferably mixed at a temperature in the range between 15 and 120° C. and preferably 20 to 80° C. and introduced into the mold or onto the belt line. The temperature in the mold is usually in the range between 15 and 120° C. and preferably between 30 and 80° C.

The density of the viscoelastic flexible polyurethane foam of the present invention is less than 150 g/l, preferably in the range from 20 to 100 g/l, more preferably in the range from 30 to 80 g/l and especially in the range from 40 to 60 g/l.

Flexible polyurethane foams of the present invention are preferably used for insulating and damping elements, especially in vehicle building, for example as carpetback coating, for upholstered, sitting or lying furniture, for mattresses or cushions, for example in the orthopedic and/or medical sector, or for shoe inlay soles. A further field of use is that of automotive safety parts, supporting areas, armrests and similar parts in the furniture sector and in automotive engineering. Viscoelastic components are further used for acoustical insulation and absorption. It is particularly preferably to use the flexible polyurethane foams of the present invention for mattresses and cushions.

The viscoelastic polyurethane foams of the present invention are characterized by excellent mechanical properties, especially outstanding values for tensile strength and elongation at break. The viscoelastic polyurethane foams of the present invention at the same time have outstanding air flow values of above 1 dm³/s. The viscoelastic polyurethane foams of the present invention are washable and can be washed and dried in commercial domestic washing machines using customary washing powders at temperatures up to 60° C. without destruction and without significant impairment, especially of viscoelastic properties and mechanical properties, such as tensile strength and elongation at break.

The examples which follow illustrate the invention.

### EXAMPLES 1 AND 2

The polyols, catalysts and addition agents reported in table 1 were mixed together to form a polyol component, the reported amounts being parts by weight. The polyol component was mixed with an MDI isocyanate mixture (diphenylmethane diisocyanate mixture) at the reported index in a Puromat equipped with MKA 10-2/16 mixing head at about 150 bar, and the mixture was introduced into a closeable metal mold having the dimensions 40×40×10 cm, where it cured to the flexible foam in the closed mold. The metal mold has a temperature of 60° C., the demolding time was 6 minutes.

The mechanical properties of the foams are reported in the tables.

polyol 1 polyether alcohol based on trimethylolpropane and propylene oxide, hydroxyl number 160 mg KOH/g

polyol 2 polyether alcohol based on glycerol, propylene oxide and ethylene oxide, hydroxyl number 170 mg KOH/g and a proportion of propylene oxide, based on the total weight of ethylene oxide and propylene oxide, of about 95 wt %

polyol 3 polyether alcohol based on glycerol and propylene oxide, hydroxyl number 42 mg KOH/g

polyol 4 polyether alcohol based on glycerol, ethylene oxide and propylene oxide, hydroxyl number 42 mg KOH/g and a proportion of ethylene oxide, based on the total weight of ethylene oxide and propylene oxide, of about 74 wt %

polyol 5 polyether alcohol based on ethylene glycol as starter and ethylene oxide, hydroxyl number 188 mg KOH/g

monool monool, hydroxyl number 406 mg KOH/g

crosslinker glycerol, hydroxyl number 1825 mg KOH/g

stabilizer 1 Dabco® DC 198 Air Products

catalyst 2 Jeffcat® ZF10—incorporable amine catalyst from Huntsman

catalyst 3 VP9357—incorporable amine catalyst from BASF SE

catalyst 4 Dabco® NE 1070—incorporable amine catalyst from Air Products

Iso 1 MDI mixture from BASF SE, NCO content 32.8%, comprising 2,4′-MDI, 4,4′-MDI and higher-nuclear homologs of MDI

detergent: commercially available Persil® laundry detergent from Henkel

TABLE 1

| Example | 1 | 2 |
|---|---|---|
| polyol 1 | 34.3 | |
| polyol 2 | | 28 |
| polyol 3 | 15 | 15.3 |
| polyol 4 | 40 | 31 |
| polyol 5 | | 20 |
| monool | 4 | |
| crosslinker | 1 | |
| stabilizer 1 | 1.0 | 1.5 |
| catalyst 2 | 0.2 | 0.2 |
| catalyst 3 | 2 | 1 |
| catalyst 4 | 1 | |
| water | 1.5 | 3.0 |
| Iso 1 | 100 | 100 |
| index | 100 | 80 |

TABLE 2

| Example | 1 | 2 |
|---|---|---|
| tan delta (max) at ° C. | 20 | 25 |
| tan delta at 20° C. | 0.68 | 0.61 |
| overall density kg/m³ | 78 | 48 |
| compressive strength 40% | 3.3 | 1.0 |
| [kPa] | | |
| tensile strength [kPa] | 190 | 136 |
| elongation at break [%] | 173 | 201 |
| CS (22 h/70° C./50%) [%] | 2.3 | 4.6 |
| CS (22 h/70° C./90%) [%] | 3.2 | 7.7 |
| hysteresis [%] | 41 | 57 |
| resilience [%] | 6 | 11 |
| air flow value [dm³/s] | 1.7 | 2.0 |

TABLE 3

| Example | 1 | 1b | 1c | 1d |
|---|---|---|---|---|
| washed at ° C. | — | 40, once | 60, once | |
| washed at ° C. + Persil | — | | | 60, once |
| overall density kg/m³ | 78 | 76 | 78 | 78 |
| compressive strength 40% | 3.3 | 3.0 | 3.4 | 3.5 |
| [kPa] | | | | |
| tensile strength [kPa] | 190 | 177 | 171 | 192 |
| elongation at break [%] | 173 | 181 | 186 | 188 |
| CS (22 h/70° C./50%) [%] | 2.3 | 2.2 | 1.9 | 1.9 |
| CS (22 h/70° C./90%) [%] | 3.2 | 3.3 | 7.6 | 8.5 |
| hysteresis [%] | 41 | 42 | 46 | 45 |
| resilience [%] | 6 | 5 | 4 | 6 |
| air flow value [dm³/s] | 1.7 | 1.7 | 1.4 | 1.5 |

TABLE 4

| Example | 2 | 2b | 2c | 2d | 2e |
|---|---|---|---|---|---|
| washed at ° C. | — | 40, | 60, | | |
| | | once | once | | |
| washed at ° C. + Persil | — | | | 60, | 40, |
| | | | | once | five × |
| overall density kg/m³ | 48 | 45 | 44 | 44 | 45 |
| compressive strength 40% | 1.0 | 1.2 | 1.3 | 1.4 | 1.5 |
| [kPa] | | | | | |
| tensile strength [kPa] | 136 | 160 | 170 | 163 | 146 |
| elongation at break [%] | 201 | 187 | 187 | 186 | 174 |
| CS (22 h/70° C./50%) [%] | 4.6 | 4.8 | 4.7 | 4.9 | 5.4 |
| CS (22 h/70° C./90%) [%] | 7.7 | 7.0 | 6.4 | 9.3 | 5.1 |
| hysteresis [%] | 57 | 62 | 63 | 65 | 66 |
| resilience [%] | 11 | 12 | 12 | 12 | 12 |
| air flow value [dm³/s] | 2.0 | 2.4 | 2.3 | 2.2 | 2.3 |

Overall density was determined according to DIN EN ISO 845, compressive strength and hysteresis according to DIN EN ISO 3386, tensile strength according to DIN EN ISO 1798, elongation at break according to DIN EN ISO 1798, compression set (CS) according to DIN EN ISO 1856, resilience according to DIN EN ISO 8307 and air flow value according to DIN EN ISO 7231.

In a washing test, a pillow was weighed and measured out beforehand and washed inside a pillow casing in a commercially available washing machine (Bomann 9110) in the heavy duty cycle at 40° C. or 60° C.

Depending on the test, Persil® from Henkel was included in the wash (1 cup). The program includes a spin at 1000 rpm. The still residually moist pillow was then weighed and measured and thereafter dried either at room temperature or at 60° C. in a circulating air oven to constant weight and then tested. In test 2e, the pillow was washed altogether five times and dried again. The pillows as dried are visually impeccable, have an intact skin structure and no cracks or visible defects.

TABLE 5
Swelling behavior and water imbibition
using test 2d as an example:

| | Before washing | After spinning | After drying |
|---|---|---|---|
| length | 100% | 108% | 99% |
| width | 100% | 109% | 100% |
| height | 100% | 109% | 98% |
| weight | 100% | 165% | 97% |
| visual assessment | impeccable | impeccable | impeccable |

The weight increase of 65% shows that the foam is hydrophilic. Nonetheless, it only swells by about 9% and is readily dryable. After drying the foam has the same geometry and the same mechanical and especially viscoelastic properties.

We claim:

1. A process for producing viscoelastic flexible polyurethane foams having an air flow value of at least 1 dm³/s, which comprises
a) polyisocyanate being mixed with
b) polymeric compounds having isocyanate-reactive groups,
c) optionally chain-extending and/or crosslinking agents,
d) optionally compounds having one isocyanate-reactive group with a hydroxyl number of 100 to 500 mg KOH/g,
e) catalyst,
f) blowing agent, and also optionally
g) addition agents
to form a reaction mixture and convert it into flexible polyurethane foam, wherein the polymeric compounds having isocyanate-reactive groups (b) comprise
b1) 10 to 40 wt % of at least one polyalkylene oxide having a hydroxyl number of 90 to 300 mg KOH/g, based on a 3 to 6-functional starter molecule and a propylene oxide fraction, based on the alkylene oxide content, of 80 to 100 wt %,
b2) 5 to 20 wt % of at least one polyalkylene oxide having a hydroxyl number of 10 to 60 mg KOH/g, based on a 2 to 4-functional starter molecule and a propylene oxide fraction, based on the alkylene oxide content, of 80 to 100 wt %,
b3) 10 to 50 wt % of at least one polyalkylene oxide having a hydroxyl number of 10 to 55 mg KOH/g, based on a 2 to 4-functional starter molecule and an ethylene oxide fraction, based on the alkylene oxide content, of 70 to 100 wt %, and
b4) 0 to 20 wt % of at least one polyalkylene oxide having a hydroxyl number of 50 to 200 mg KOH/g, based on a 2-functional starter molecule and an ethylene oxide fraction, based on the alkylene oxide content, of 80 to 100 wt %,
and
wherein the fraction of compounds b1) to b4), based on the total weight of polymeric compounds having isocyanate-reactive groups (b), is at least 80 wt %.

2. The process according to claim 1 wherein the fraction of monool (d) is from 0.1 to 5 wt %, based on the total weight of polymeric compounds having isocyanate-reactive groups (b) and compounds having one isocyanate-reactive group (d).

3. The process according to claim 1 or 2 wherein the fraction of compounds b1) to b4), based on the total weight of polymeric compounds having isocyanate-reactive groups (b), is at least 95 wt %.

4. The process according to any of claims 1 to 3 wherein the tensile strength of viscoelastic polyurethane foam is at least 100 kPa.

5. The process according to any of claims 1 to 4 wherein the absolute maximum of the loss modulus lies in the temperature range from 15 to 30° C.

6. The process according to any of claims 1 to 5 wherein polyisocyanate (a) comprises diphenylmethane diisocyanate.

7. The process according to any of claims 1 to 6 wherein polyisocyanate (a) comprises toluene diisocyanate.

8. The process according to any of claims 1 to 7 wherein polyisocyanate (a) comprises isocyanate prepolymers.

9. The process according to any of claims 1 to 8 wherein said blowing agent (c) comprises water.

10. The process according to claim 9 wherein the fraction of water, based on the total weight of components (a) to (f), is from 1 to 5 wt %.

11. The process according to any of claims 1 to 10 wherein the step of curing the reaction mixture to the polyurethane foam takes place in a mold.

12. The process according to any of claims 1 to 11 wherein the reaction mixture is foamed free-risen.

13. The process according to any of claims 1 to 11 wherein the reaction mixture is foamed in a closed mold.

14. A viscoelastic flexible polyurethane foam obtainable according to any of claims 1 to 13.

15. The use of a viscoelastic polyurethane foam according to claim 14 in vehicle interiors or for mattresses and cushions.
